(19) United States
(12) Patent Application Publication
(10) Pub. No.: US 2019/0014711 A1
(43) Pub. Date: Jan. 17, 2019

(54) SHOVEL

(71) Applicant: Timothy Shull, Victoria, TX (US)

(72) Inventor: Timothy Shull, Victoria, TX (US)

(21) Appl. No.: 16/021,005

(22) Filed: Jun. 27, 2018

Related U.S. Application Data
(60) Provisional application No. 62/531,358, filed on Jul. 12, 2017.

(51) Int. Cl. A01B 1/02

(52) U.S. Cl. CPC A01B 1/02

(57) ABSTRACT

A shovel including a substantially spade-shaped blade. The substantially spade-shaped blade may include an inverted tip and rounded edges. A socket may be attached to the blade. A shaft may be secured at a first end to the blade through the socket.

### CROSS-REFERENCE TO RELATED APPLICATION

The present application claims the benefit of priority to U.S. Provisional Patent Application No. 62/531,358, filed Jul. 12, 2017, titled “SHOVEL”, which is hereby incorporated by reference in its entirety.

### FIELD

Aspects of the present disclosure relate to shovels, and more particularly to shovel blades.

### BACKGROUND

Shovels are commonly used as a convenient way to perform various yard work type activities such as digging, lifting, and removing materials, etc. Most shovels are hand tools, and they come in a variety of shapes, sizes, and designs.

### SUMMARY

According to aspects of the present disclosure, a shovel provides improved results when, for example, digging in tough soil, cutting through roots and grass, shoveling materials, and other yard work type activities. The shovel may include a substantially spade-shaped blade. The substantially spade-shaped blade may include an inverted tip and rounded edges. A socket may be attached to the blade. A shaft may be secured at a first end to the blade through the socket.

According additional aspects of the present disclosure, a method of shoveling may include removing obstacles using a shovel. The shovel may include a substantially spade-shaped blade attached to a shaft. The blade may include an inverted tip and rounded edges. A socket may be attached to the blade. The shaft may be secured at a first end to the blade through the socket. The method may further include severing the obstacles using the inverted tip.

According to additional aspects of the present disclosure, a shovel may include a substantially spade-shaped blade. The substantially spade-shaped blade may include an inverted tip and rounded edges. The inverted tip may be substantially V-shaped. The shovel may further include at least one foot ledge on the blade. A socket may be attached to the blade. A shaft may be secured at a first end to the blade through the socket. A handle may be attached to a second end of the shaft.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

Other systems, methods, features and advantages of the present invention will be or will become apparent to one of ordinary skill in the art upon examination of the following figures and detailed descriptions. It is intended that all such additional apparatuses, systems, methods, features and advantages be included within this description, be within the scope of the present invention, and be protected by the appended claims. Component parts shown in the drawings are not necessarily to scale, and may be exaggerated to better illustrate the important features of the present invention. In the drawings, like reference numerals designate like parts throughout the different views.

FIG. 1 is a top view of a shovel according to aspects of the present disclosure.

FIG. 2 is a perspective view of the shovel of FIG. 1, according to aspects of the present disclosure.

FIG. 3 is a perspective view of a bottom of the shovel of FIG. 1, according to aspects of the present disclosure.

FIG. 4 illustrates a process flow diagram of a method for using a shovel according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

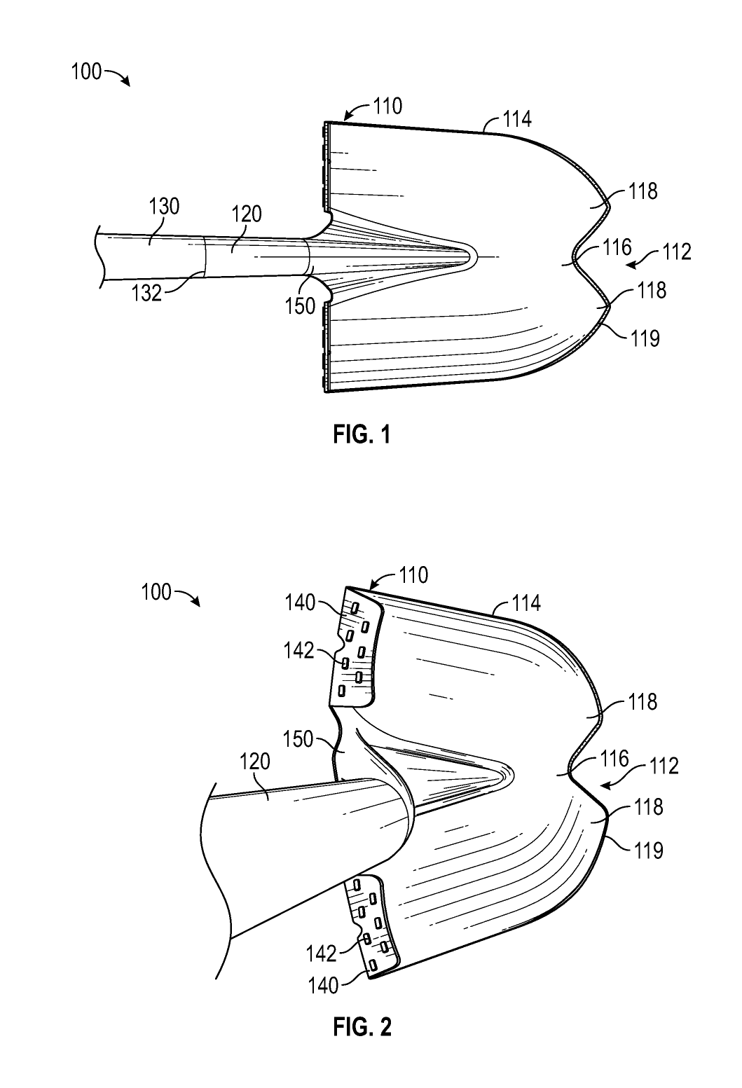

FIGS. 1-3 illustrate various views of a shovel 100 according to aspects of the present disclosure. The shovel 100 may include a substantially spade-shaped blade 110. The substantially spade-shaped blade 110 may include an inverted tip 112 and rounded edges 114. A socket 120 may be attached to the blade 110. A shaft 130 may be secured at a first end 132 to the blade through the socket 120. The shaft 130 and the socket 120 may each be substantially circular.

According to aspects of the present disclosure, the inverted tip 112 may include at least one valley portion 116 between at least two ridge portions 118. For example, the valley portion 116 may be substantially V-shaped and rounded. The ridges 118 may also be rounded. The valley portion 116 may be located between the ridges 118, such that the inverted tip 112 as a whole is substantially M or W shaped.

According to additional aspects, additional valley portions and ridge portions may be included. For example, two valleys between three ridges, three valleys between four ridges, etc. A size of the valley portion 116 and ridge portions 118 may be similar to each other. For example, a concavity of the valley portion 116 may match a convexity of each ridge portion 118. The concavity of the valley portion 116 and the convexity of the ridge portion 118 may also vary with each other. For example, the valley portion 116 may be wider or narrower than each ridge portion 118.

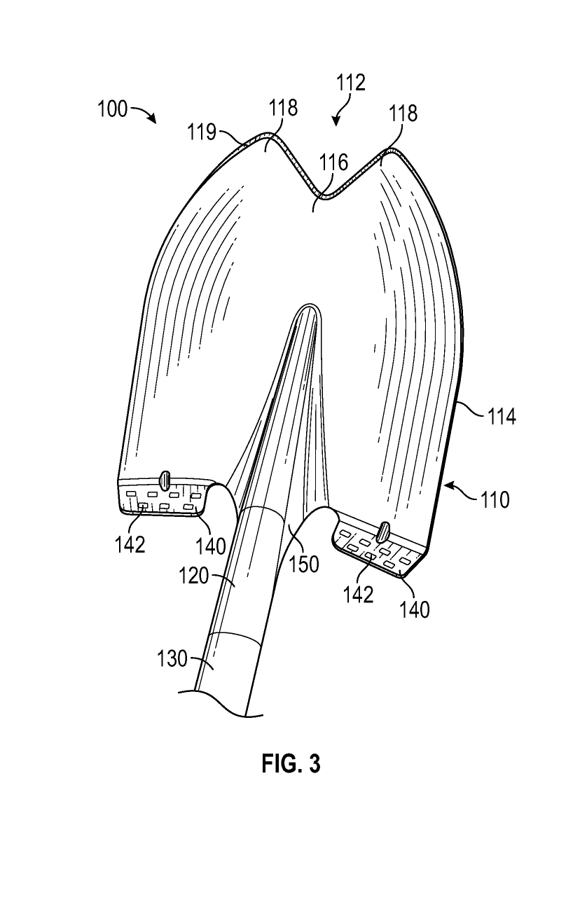

According to aspects of the present disclosure, the at least one valley portion 116 and the at least two ridge portions 118 may each be sharpened. For example, a front edge portion 119, which runs along a portion of the rounded edges 114 through the inverted tip 112, may be sharpened for improved digging, shoveling, lifting, etc. As illustrated in FIGS. 2 and 3, the front edge portion 119 may be sharpened from the front and/or the back of the shovel 100.

According to aspects of the present disclosure, the shovel 100 may further include at least one foot ledge 140 on the blade. For example, the at least one foot ledge 140 may be spaced apart from the socket 120 on a rear portion of the blade 110. Another foot ledge 140 may be located on an opposite side of the rear portion of the blade 110, symmetric to a longitudinal axis of the socket 120. According to an aspect, the at least one foot ledge 140 may include treads 142. For example, the treads 142 may be for engaging with a foot of a user to provide traction and leverage when using the shovel 100. The treads 142 may be circular, ovular, triangular, rectangular, pentagonal, or otherwise polygonal in shape. According to an aspect, the treads 142 may be formed as indentations on the at least one foot ledge 140.

According to additional aspects of the present disclosure, the shovel 100 may further include a handle (not shown) attached to a second end (not shown) of the shaft 130 distal from the first end 132 of the shaft 130. For example, the handle may be a standard handle at the second end of the shaft 130, which is useful for transporting, storing, and using the shovel 100 by hand.

According to additional aspects of the disclosure, the blade 110 may be substantially concave when viewed from the top. The blade 100 may further include a raised center portion 150. For example, the raised center portion 150 may be located adjacent to the socket 120.

According to aspects of the present disclosure, each of the blade 110, socket 120, and shaft 130 may be formed from various known materials, such as, including, but not limited to, woods, metals, plastics, fiberglass, alloys, compounds, and other materials. The shaft 130 may be attached to the socket 120 through various known means, including, but not limited to, friction fit, screw fit, glued, welded, formed from a single piece, etc. The socket 120 may be attached to the raised center portion 150 through various known means, including, but not limited to, welding, formed from a single piece, etc. The raised center portion 150 may be formed through known molding processes.

According to aspects of the present disclosure, the socket 120 may be substantially longer than the raised center portion 150. For example, the socket 120 may be ⅓ of a length of the shaft 130. Of course, other lengths are possible for the socket 120. A longer socket 120 may provide better leverage as a fulcrum (e.g., a stronger fulcrum) for the shovel 100 when it is in use than if the socket 120 were shorter. For example, the shaft 130 may attach to the blade 110 at the raised center portion 150, and the socket 120 may add additional support for the shaft 130 when in use. Additionally, the shaft 130 may attach to the blade 110 at a point in the socket 120 between the first end 132 and the raised center portion 150 (e.g., at a midpoint, or any other point, etc.).

According to aspects of the present disclosure, the blade 110 including the inverted tip 112 may be formed through known molding processes. Additionally, the inverted tip 112 may be formed through ordinary use of a conventional spade-tipped shovel. For example, the spade tip may be dented inwardly by a rock in the ground during normal use of the conventional shovel, and through successive uses (e.g., such as ordinary house and yard work), the dent may be further honed and smoothed to result in a shape of the inverted tip 112.

Advantages of using the shovel 100 include improved performance when, for example, completing yard duties such as digging, shoveling, lifting, etc. For example, the inverted tip 112 of the shovel 100 provides a recessed area for capturing and cutting through aboveground and underground obstacles, such as roots, grass, and vegetation. Additionally, the at least two-prongs provided by the ridges 118 allow for faster and easier digging by providing multiple contact areas with the ground. For example, the at least two points of contact with the ground allow for two points of penetration, rather than just one for a conventional shovel. This also provides improved stability for the shovel 100 when in use. Furthermore, the sharpened front edge 119 allows for quicker and easier cutting of obstacles. The sharpened front edge 119 also provides more leverage when shoveling or lifting materials, allowing for easier scooping, wedging, pivoting, and lifting.

Aspects of the present disclosure provide at least two sharpened edges (e.g., ridge portions 118) joined together to form a V shape (e.g., to form a valley portion 116). For example, the V shape may be two sharpened edges joined in an inversion. This configuration allows for better digging and cutting, as discussed above and herein. For example, the V shape gathers and captures obstacles, while the sharpened edges cut through or into the obstacles. This configuration may be implemented in a variety of tools, other than shovels, such as, including, but not limited to, spoons, hand shovels, trowels, knives, hand tools, etc. According to additional aspects of the present disclosure, more than two sharpened edges may be implemented, as discussed above and herein.

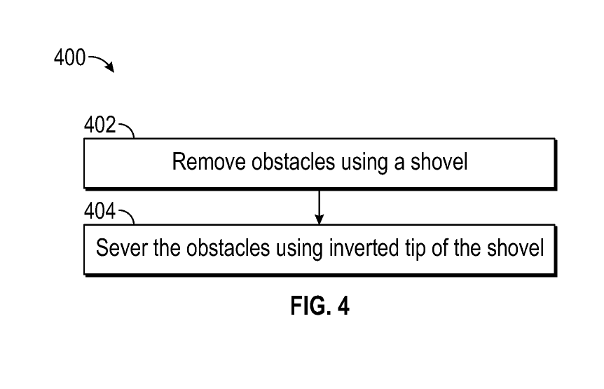

FIG. 4 illustrates a process flow diagram of a method 400 for using a shovel according to aspects of the present disclosure. The method 400 may include, at step 402, removing obstacles using a shovel. Referring to FIGS. 1-3, for example, the shovel 100 may include a substantially spade-shaped blade 110 attached to a shaft 130. The blade 110 may include an inverted tip 112 and rounded edges 114. A socket 120 may be attached to the blade 110. The shaft 130 may be secured at a first end 132 to the blade 110 through the socket 120. The shovel 100 may be used to remove obstacles, such as vegetation, grass, roots, dirt, debris, tough, soil, gravel, snow, sand, ore, or other above-ground and/or underground materials.

At step 404, the obstacles may be severed using the inverted tip of the shovel. Referring to FIGS. 1-3, for example, the inverted tip 112 of the shovel 100 provides a recessed area for capturing and cutting through the aboveground and/or underground obstacles during the process of digging, shoveling, lifting, etc. According to an aspect of the present disclosure, the obstacles may first be positioned between the inverted tip prior to the act of digging, shoveling, lifting, etc.

The specification and drawings are, accordingly, to be regarded in an illustrative rather than a restrictive sense. It will, however, be evident that various modifications, combinations, and changes may be made thereunto without departing from the broader spirit and scope of the disclosure as set forth in the claims.

The description of the subject technology is provided to enable any person skilled in the art to practice the various embodiments described herein. While the subject technology has been particularly described with reference to the various figures and embodiments, it should be understood that these are for illustration purposes only and should not be taken as limiting the scope of the subject technology.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various embodiments described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted.

The previous description of the disclosure is provided to enable any person skilled in the art to make or use the disclosure. Various modifications and combinations to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A shovel comprising:
a substantially spade-shaped blade comprising an inverted tip and rounded edges;
a socket attached to the blade; and
a shaft secured at a first end to the blade through the socket.

2. The shovel of claim 1, in which the inverted tip comprises at least one valley portion between at least two ridge portions.

3. The shovel of claim 2, in which the at least one valley portion is sharpened.

4. The shovel of claim 2, in which the at least one valley portion is rounded.

5. The shovel of claim 2, in which the at least two ridge portions are sharpened.

6. The shovel of claim 2, in which the at least two ridge portions are rounded.

7. The shovel of claim 1, further comprising at least one foot ledge on the blade.

8. The shovel of claim 7, in which the at least one foot ledge is spaced apart from the socket.

9. The shovel of claim 7, in which the at least one foot ledge comprises a plurality of treads.

10. The shovel of claim 9, in which the plurality of treads are circular, ovular, triangular, rectangular, pentagonal, or otherwise polygonal in shape.

11. The shovel of claim 9, in which the plurality of treads are indentations in the at least one foot ledge.

12. The shovel of claim 1, further comprising a handle attached to a second end of the shaft.

13. The shovel of claim 1, in which the blade is substantially concave.

14. The shovel of claim 1, in which the blade includes a raised center portion, the raised center portion adjacent to the socket.

15. The shovel of claim 1, in which the socket is substantially circular.

16. The shovel of claim 1, in which the shaft is substantially circular.

17. A method of shoveling comprising:
removing obstacles using a shovel comprising:
a substantially spade-shaped blade attached to a shaft, the blade comprising an inverted tip and rounded edges,
a socket attached to the blade, and
a shaft secured at a first end to the blade through the socket, and severing the obstacles using the inverted tip of the shovel.

18. The method of claim 17, further comprising positioning the obstacles between the inverted tip.

19. The method of claim 17, in which the obstacles include at least one of vegetation, grass, roots, dirt, debris, tough, soil, gravel, snow, sand, ore, or other above-ground and/or underground materials.

20. A shovel comprising:
a substantially spade-shaped blade comprising an inverted tip and rounded edges, the inverted tip substantially V-shaped;
at least one foot ledge on the blade;
a socket attached to the blade;
a shaft secured at a first end to the blade through the socket; and
a handle attached to a second end of the shaft.
